(19) United States
(12) Patent Application Publication
(10) Pub. No.: US 2007/0177964 A1
(43) Pub. Date: Aug. 2, 2007

(54) Vehicle mounted loader

(76) Inventor: Paul A. Bosela, Copley, OH (US)

Correspondence Address: FAY SHARPE LLP, 1100 SUPERIOR AVENUE, SEVENTH FLOOR, CLEVELAND, OH, 44114, US

(21) Appl. No.: 11/656,856

(22) Filed: Jan. 23, 2007

Related U.S. Application Data
(60) Provisional application No. 60/762,546, filed on Jan. 27, 2006.

(51) Int. Cl. B60R 9/042; B60P 9/00

(52) U.S. Cl. 414/462; 224/310; 414/538

(57) ABSTRACT

A loader is releasably mounted to an associated vehicle rack. The loader has a first generally horizontal position for transporting an associated boat and a second position inclined downwardly at an angle of inclination to the generally horizontal first position for launching and loading the associated boat in a predominately upright position. The loader comprises an outer frame assembly and an inner frame assembly. The outer frame assembly is configured for pivotal engagement with the associated vehicle rack. The inner frame assembly is at least partially telescopically received in the outer frame assembly. In the first position, the inner frame assembly is releasably secured within the outer frame assembly. In the second position, the outer frame assembly is at least partially rotated about a horizontal transverse axis defined by the associated vehicle rack and the inner frame assembly at least partially extends telescopically outwardly from the outer frame assembly.

### CROSS REFERENCE TO RELATED APPLICATIONS

This application claims priority from U.S. Provisional Patent Application Ser. No. 60/762,546 filed Jan. 27, 2006 and is incorporated herein by reference.

### BACKGROUND OF THE INVENTION

The present invention generally relates to a vehicle mounted loader. More particularly, the present invention relates to a loader for loading, transporting and launching a small and lightweight boat. The loader is removably mounted on a top rack secured to a vehicle, such as a pickup truck.

Vehicle-top loaders for boats are in common use. However, most pose significant problems for an individual to use. Although a “light” boat, such as a canoe or kayak, can be easily lifted onto a conventional vehicle-top loader, it is oftentimes difficult, if not impossible, for most adults to lift a small and lightweight boat, such as a fishing boat, onto the vehicle-top loader.

The prior art includes several loading and transporting devices that enable an individual to load and transport a small and lightweight boat. Representative examples of such prior art devices are disclosed in the U.S. Pat. No. 4,003,485 issued to Edgerton; U.S. Pat. No. 4,212,580 issued to Fluck; U.S. Pat. No. 4,274,788 issued to Sutton; U.S. Pat. No. 4,907,934 issued to Holladay; U.S. Pat. No. 5,511,928 issued to Ellis; U.S. Pat. No. 5,609,462 issued to Reimer; U.S. Pat. No. 6,357,991 issued to Hamlett; and U.S. Pat. No. 6,726,073 issued to Sutton. Many of the prior art devices include winches and cables to either pull the boat up an incline track or to rotate the boat onto a vehicle rack using a pivot post attached to a trailer hitch. While both methods provide mechanical advantage to allow an individual to load a boat onto a vehicle, there are drawbacks to the prior art loaders.

To be effective in manually lifting a heavy load, such as a small and lightweight boat, up an incline generally requires a top loader to include long side rails to reduce the angle of the slope. However, the long rails result in storage problems while transporting the boat. Loaders which use multiple pivoting deployable frames are unnecessarily complicated, and may be more prone to failure with repetitive use. Many require a portion of the deployable frame to be mounted onto the truck bed, reducing the storage space of the vehicle and preventing the use of a tonneau cover on the truck bed. Loaders which rotate the boat about a pivot post do not have adequate mechanical advantage, and rely more on the advantage of the winch alone to rotate the boat into an inverted position on the top rack. Other disadvantages of that particular type of loader include the rotating of the boat itself, which requires that all the associated boat gear be unloaded from the boat before loading it onto the vehicle top rack, and negate the ability to readily store such gear in the boat during transportation. The unloading also undesirably results in the bow, rather than the stern, of the boat facing the water during launch.

Other prior art devices reduce the mechanical advantage required by pulling the boat into the bed of the pickup, rather than raising it to a height where it can extend above the truck cab. This causes a great deal of the boat stern and carrier to extend pass the rear of the truck, particularly if the truck has a compact bed.

Accordingly, there is a need for an improved vehicle mounted loader for loading, transporting and launching a small and lightweight boat which overcomes certain difficulties with the conventional designs while providing better and more advantageous overall results.

### BRIEF DESCRIPTION OF THE INVENTION

In accordance with one aspect of the present disclosure, a loader is releasably mounted to an associated vehicle rack. The loader has a first generally horizontal position for transporting an associated boat and a second position inclined downwardly at an angle of inclination to the generally horizontal first position for launching and loading the associated boat in a predominately upright position. The loader comprises an outer frame assembly and an inner frame assembly. The outer frame assembly is configured for pivotal engagement with the associated vehicle rack. The inner frame assembly is at least partially telescopically received in the outer frame assembly. In the first position, the inner frame assembly is releasably secured within the outer frame assembly. In the second position, the outer frame assembly is at least partially rotated about a horizontal transverse axis defined by the associated vehicle rack and the inner frame assembly at least partially extends telescopically outwardly from the outer frame assembly.

In accordance with another aspect of the present invention, a loader is releasably mounted to an associated vehicle rack for launching, loading and transporting an associated boat in a predominately upright position. The loader comprises an outer frame assembly pivotally connected to the associated vehicle rack and an inner frame assembly. The outer frame assembly includes first and second spaced apart, longitudinally extending rails. At least one transverse member connects the first and second rails. The inner frame assembly includes first and second longitudinally extending rails. The first rail is telescopically housed in the first rail of the outer frame assembly, and the second rail is telescopically housed in the second rail of the outer frame assembly. A lifting system is operably connected to the outer frame assembly for pulling the associated boat onto the loader and for allowing the associated boat to be controllably lowered off the loader.

In accordance with yet another aspect of the present invention, a loader is releasably mounted to an associated vehicle rack. The loader has a first generally horizontal position for transporting an associated boat and a second position inclined downwardly at an angle of inclination to the generally horizontal first position for launching and loading the associated boat in a predominately upright position. The loader comprises a generally ladder-shaped outer frame assembly and a generally U-shaped inner frame assembly. The outer frame assembly has a first end section pivotally mounted to the associated vehicle rack. The inner frame assembly is telescopically housed in the outer frame assembly for movement between a stowed position and an extended position. A winch system is operably connected to one of the outer frame assembly and the associated vehicle rack for pulling the associated boat onto the loader and for allowing the associated boat to be controllably lowered off the loader.

A benefit of the present invention is the ability to launch a boat into a body of water, regardless of whether there is an available boat ramp.

Another benefit of the present invention is the ability to launch and load a boat while retaining the boat in a predominately upright position.

Still another benefit of the present invention is the ability to launch and/or load a boat without the wheels of the vehicle being at least partially immersed in water.

Still yet another benefit of the present invention is the ability to transport, launch and/or load a boat while transporting a second boat on a conventional trailer attached to a vehicle.

Still other benefits and aspects of the invention will become apparent from reading and understanding the detailed description of the embodiment hereinbelow.

### BRIEF DESCRIPTION OF THE DRAWINGS

The present invention may take physical form in certain parts and arrangements of parts, an embodiment of which will be described in detail in this specification and illustrated in the accompanying drawings which form a part of the invention.

FIG. 1 is a schematic view of a vehicle mounted loader according to the present invention, the loader being removably mounted on a vehicle top rack.

FIG. 2 is a schematic side view of the loader of FIG. 1 mounted to a pickup truck, the loader being in an extended and tilted position to pull a boat out of a body of water.

FIG. 3 is a schematic side view of the loader of FIG. 1 showing a boat pulled to its loaded position above a roof rack of a pickup truck.

FIG. 4 is a schematic side view of the loader of FIG. 1 showing the loader in a generally horizontal transport position above the vehicle roof rack.

### DETAILED DESCRIPTION OF THE INVENTION

It should, of course, be understood that the description and drawings herein are merely illustrative and that various modifications and changes can be made in the structures disclosed without departing from the spirit and scope of the invention. It will also be appreciated that the various identified components of the vehicle mounted loader disclosed herein are merely terms of art that may vary from one manufacturer to another and should not be deemed to limit the present invention. All references to direction and position, unless otherwise indicated, refer to the orientation of the apparatus illustrated in the drawings.

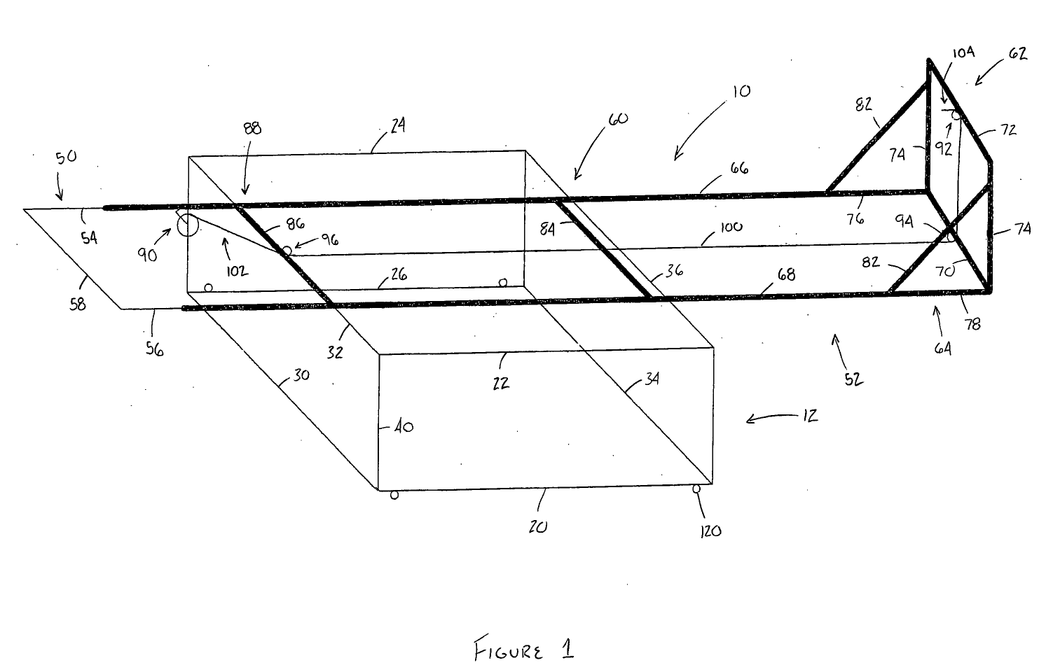

Referring now to the drawings, wherein like numerals refer to like parts throughout the several views, FIG. 1 illustrates a vehicle mounted loader, generally designated by reference numeral 10, in accordance with the present invention, removably mounted atop a conventional vehicle rack, generally designated by reference numeral 12. The loader has a first generally horizontal position for transporting a boat, generally designated by reference letter B, and a second position inclined downwardly at an angle of inclination to the generally horizontal first position for launching and loading the boat in a predominately upright position.

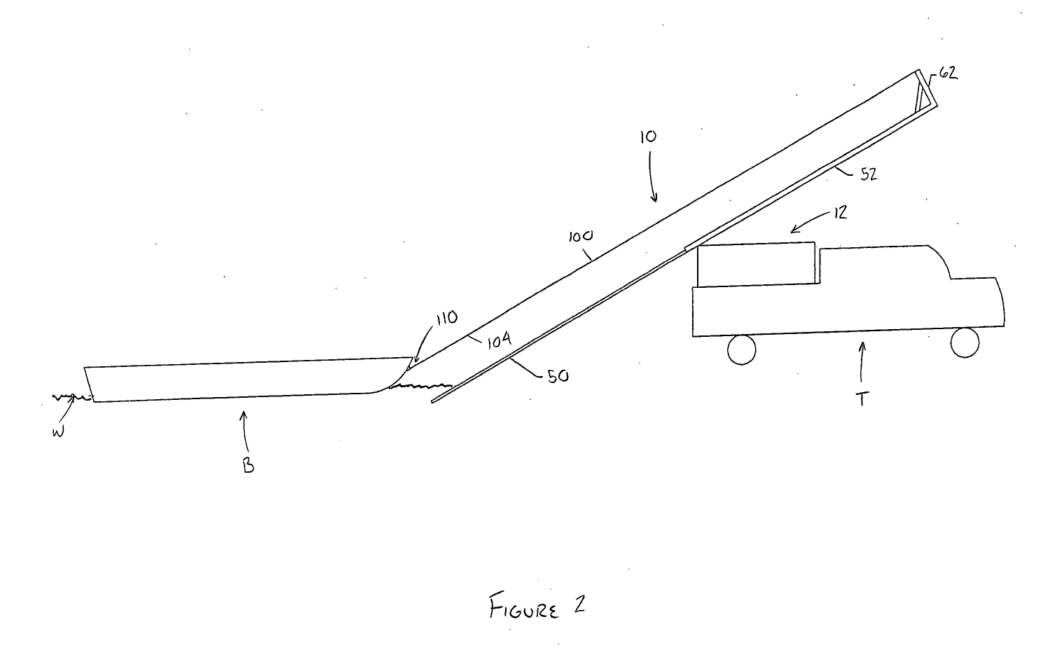

As is well known, the stationary vehicle rack 12 generally includes opposed longitudinal rails 20, 22, 24, 26; opposed transverse rails 30, 32, 34, 36; and a plurality of vertical members 40. The longitudinal and transverse rails and vertical members can be connected using 3-way structural fittings; although, this is not required. As shown in FIG. 2, the vehicle rack can be removable mounted on a vehicle, such as a pickup truck, generally designated by reference letter T, by conventional manners. For example, the vehicle rack 12 can be mounted by metal clasps and double eye turnbuckles which attach to eyes which are standard features in many pickup trucks. The vehicle rack 12 is generally constructed of corrosion resistant pipe. The upper rear transverse rail 32, which can be at least partially surrounded with a low friction material, serves as a horizontal transverse axis of rotation for the loader 10. Further details of the above vehicle rack are generally conventional and understood by one skilled in the art so that further discussion herein is deemed unnecessary.

With continued reference to FIG. 1, the loader 10 includes an inner frame assembly 50 at least partially telescopically received in an outer frame assembly 52. A restraining member (not shown), such as a rope, cable, tether and the like, prevents the inner frame assembly from overextending and slipping out of the outer frame assembly during transit. Although, it should be appreciated that alternate locking devices can be used to prevent accidental deployment of the inner frame assembly. For example, the outer frame assembly can include at least one rotatable safety tab (not shown). The safety tab can be positioned so that when the outer frame assembly is in the first transport position, the safety tab engages the inner frame assembly so that in a sudden stop, the safety tab will press against the inner frame assembly to restrict its movement.

The inner frame assembly 50 includes opposed first and second longitudinally extending side rails 54 and 56, respectively. In this embodiment, the inner frame assembly is generally U-shaped and further includes a cross member 58 connected to a respective end section of each rail via conventional manners. For example, the side rails can be connected to the end member by structural ninety degree angle fittings. The inner frame assembly can be formed of a corrosion resistant, low-friction material for reducing friction between the first and second rails 54, 56 and the boat during loading and unloading of the boat and for centering the boat between the rails. For example, each side rail 54, 56 and end member 58 can be made of a corrosion resistant pipe which is enclosed by and secured to a low-friction tubular member. It should be appreciated that alternate manners for reducing friction between the inner frame rails and the boat are contemplated. For example, a plurality of rollers (not shown), which can be conformable to the boat B, can be pivotally mounted to the first and second rails 54, 56, the diameter of the rollers being approximately equal to the cross-sectional width of the rails so that the rollers can be housed within the outer frame assembly.

The outer frame assembly 52 comprises a stationary member 60 fixedly attached to an end assembly 62 at a first end section 64 of the stationary member. The stationary member includes opposed first and second side rails 66 and 68, respectively. The end assembly is generally rectangular in shape and includes lower and upper cross members 70 and 72, respectively, and a pair of vertical members 74. It should be appreciated that alternate shapes for the end assembly are contemplated. To assemble the outer frame assembly 52, each side rail includes a first end section 76, 78 connected to one of the vertical members 74 and the lower cross member 70 via conventional manners, such as structural three-way fittings. The vertical members 74 are connected to the upper cross member 80 via conventional manners, such as structural ninety degree angle fittings.

At least one support member is provided to add further strength to the outer frame assembly 52. In this embodiment, a pair of support members 82 is provided. Each support member extends between a respective first end section 76, 78 of each outer frame rail 66, 68 and a vertical member 74 and is connected thereto via conventional manners, such as a Y-fitting. The support members also provide additional stability against vertical deflecting forces and maintain the generally perpendicular relationship between the stationary member 60 and the end assembly 62. Transverse stability is further provided by at least one transverse member connected to one of the first and second rails 66, 68. In this embodiment, transverse members 84 and 86 are spaced from the lower cross member 70. Each transverse member spans between and is connected to the first and second rails 66, 68 via conventional manners, such as structural crossover fittings. The outer frame assembly 52 is formed of a corrosion resistant, low-friction material. Similar to the inner frame assembly, a plurality of rollers (not shown) can be mounted to the first and second rails 66, 68 to aid in the loading and unloading of the boat and for centering the boat between the outer frame rails.

A second end section 88 of the outer frame assembly 52 is rotatably attached to the vehicle rack 12 via conventional manners. For example, structural cross over fittings can be used to rotatably attach transverse member 86 of the outer frame assembly to upper rear transverse rail 32 of the vehicle rack. This allows the loader 10 to rotate freely about the vehicle rack 12.

As shown in FIG. 1, a lifting system is mounted to the loader 10 and vehicle rack 12 for providing mechanical advantage to pull the boat onto the rotated and extended loader for transportation or to controllably lower the boat off the rotated and extended loader to launch the boat. The system includes a manual or electric winch 90 of conventional design operably attached to one of the loader and the vehicle rack. In this embodiment, the winch is attached to one of the rear vertical members 40. At least one pulley is attached to the outer frame assembly 52. In the depicted embodiment, pulleys 92 and 94 are attached to the respective upper and lower cross members 72 and 70 of the end assembly 62, and pulley 96 is attached to transverse member 86 of the stationary member 60. The pulleys are mechanically connected to the winch 90 via an elongated connecting element 100, such as a rope, cable, tether and the like. The connecting element has a first end section 102 coupled to the winch 42 and a second end section 104 coupled to the boat B. For example, as shown in FIGS. 2-4, the connecting element can be secured to a bow eye 110 mounted to the boat. The connecting element can be used for securing the boat B to the loader 10, launching the boat from the loader and/or loading the boat onto the loader.

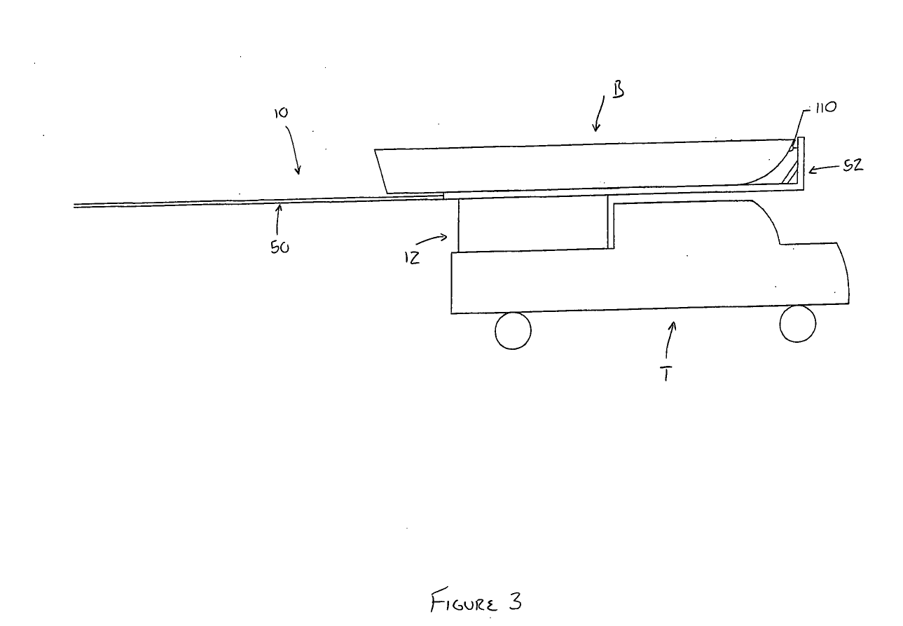

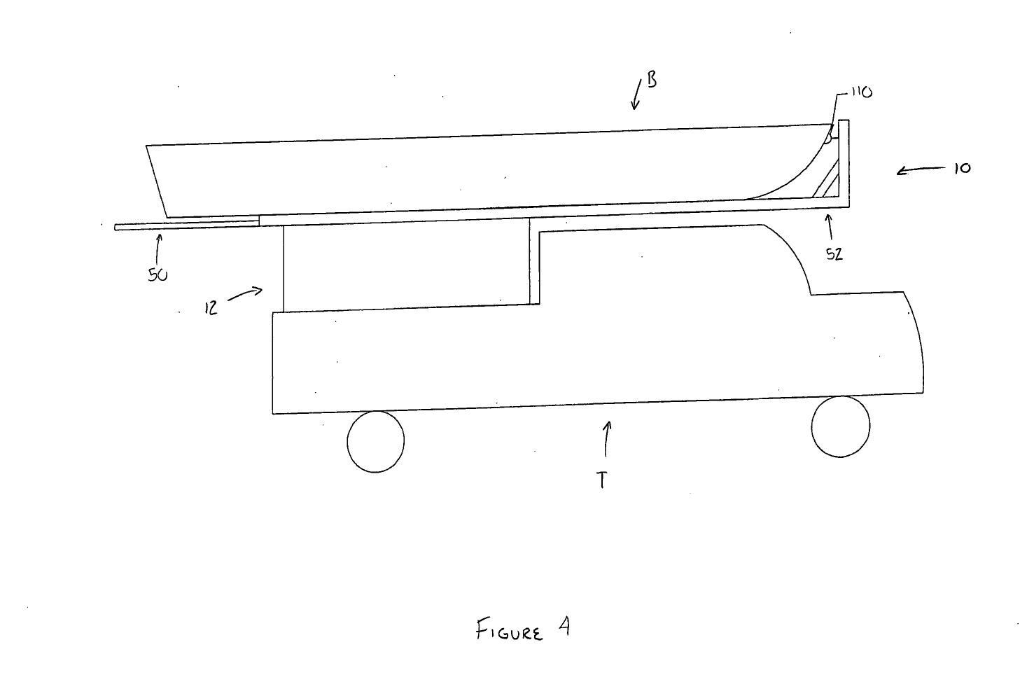

With continued reference to FIGS. 2-4, the loading of the boat B from a body of water W onto the loader 10 is illustrated. As shown in FIG. 2, the loader is rotated about the vehicle rack 12 thereby allowing the inner frame assembly 50 to telescopically slide out of the outer frame assembly 52. In this position, the total length of the loader is approximately twice the length of the boat. The end section 104 of the connecting element 100 is affixed to the boat. As the connecting element is being winched, the boat slides onto the rails 52, 54 of the inner frame assembly. The boat, which is now supported by the rails 52, 54, is continually pulled up the inner frame assembly and onto the rails 66, 68 of the outer frame assembly 52 by the lift system. As the boat moves up the rails 66, 68, the loader 10 will reach a balance point. At this point, the weight of the boat will cause the loader 10 to rotate downwardly about the vehicle rack 12 to the horizontal position, such that the loader rests on the vehicle rack (FIG. 3). The boat is pulled forward until the bow of the boat can be firmly secured to the end assembly 62. For example, the boat can be secured to the loader using ratchet tie downs attached to corrosion resistant structural eye bolts 120 (FIG. 1) mounted to the vehicle rack. In the secured first position, the weight of the boat is removed from the inner frame assembly rails 52, 54. This allows the inner frame assembly 50 to be easily slid back into the outer frame assembly 52 for transportation (FIG. 4). The loader 10 is then secured to the vehicle rack via conventional manners to prevent accidental rotation of the loader during transport. For example, a self-locking pin with a lanyard can be used to secure the loader to the vehicle rack in the first horizontal position. The restraining element (not shown) is reconnected to prevent the inner frame assembly from accidental extension during transit.

The procedure to launch the boat B from the loader 10 is simply the reverse of the above description with respect to loading the boat. It should also be apparent that the loader launches the boat stern first, similar to a traditional boat trailer.

As is evident from the foregoing, the loader 10 allows a single individual to quickly load and unload a small and lightweight boat while maintaining the boat in an upright position so that all associated boat gear does not have to be manually loaded and unloaded. The loader is extremely sturdy and resistant to deterioration, due to the use of corrosion resistant materials. It is also designed such that vehicle wheels do not have to be immersed in water during launching, and the loader can be easily removed from the vehicle.

The present disclosure has been described with reference to the above embodiment. Obviously, modifications and alterations will occur to others upon reading and understanding the preceding detailed description. It is intended that the disclosures be construed as including all such modifications and alterations insofar as they come within the scope of the claims appended hereto, as well as their equivalents.

What is claimed is:

1. A loader releasably mounted to an associated vehicle rack, the loader having a first generally horizontal position for transporting an associated boat and a second position inclined downwardly at an angle of inclination to the generally horizontal first position for launching and loading the associated boat in a predominately upright position, the loader comprising:
an outer frame assembly configured for pivotal engagement with the associated vehicle rack; and
an inner frame assembly at least partially telescopically received in said outer frame assembly,
wherein in said first position, said inner frame assembly is releasably secured within said outer frame assembly,
wherein in said second position, said outer frame assembly is at least partially rotated about a horizontal transverse axis defined by the associated vehicle rack and said inner frame assembly at least partially extends telescopically outwardly from said outer frame assembly.

2. The loader of claim 1, wherein said outer frame assembly includes first and second spaced apart, longitudinally extending rails and at least one transverse member connected to at least one of said first and second rails.

3. The loader of claim 2, wherein said first and second rails are rotatably connected to the associated vehicle rack.

4. The loader of claim 2, wherein said at least one transverse member is rotatably connected to the associated vehicle rack.

5. The loader of claim 2, wherein said outer frame assembly includes at least two spaced apart transverse members, each transverse member being connected to said first and second rails.

6. The loader of claim 2, wherein said outer frame assembly further includes an end assembly connected to a first end section of at least one of said first rail and said second rail, said end assembly configured to secure the associated boat to said loader in said first position.

7. The loader of claim 6, wherein said outer frame assembly further includes at least one strengthening member, said at least one strengthening member having a first end section connected to one of said first rail and said second rail and a second end section connected to said end assembly.

8. The loader of claim 1, wherein said inner frame assembly includes first and second spaced apart, longitudinally extending rails.

9. The loader of claim 8, wherein said inner frame assembly is generally U-shaped, a respective end section of said first rail and said second rail being connected to a cross member.

10. The loader of claim 1, wherein said outer frame assembly is generally ladder-shaped.

11. The loader of claim 1, further comprising a lifting system for pulling the associated boat onto the loader and for allowing the associated boat to be controllably lowered off the loader, said lifting system including:
a winch mounted to one of said loader and the associated vehicle rack,
at least one pulley mounted to said outer frame assembly, said at least one pulley being operably connected to said winch, and
an elongated connecting element operably engaged with said at least one pulley, said elongated connecting element having a first end section connected to said winch and a second end section connected to the associated boat.

12. The loader of claim 1, wherein said outer frame assembly is formed of a corrosion resistant, low-friction material.

13. The loader of claim 1, wherein said inner frame assembly is formed of a corrosion resistant, low-friction material.

14. A loader releasably mounted to an associated vehicle rack for launching, loading and transporting an associated boat in a predominately upright position, the loader comprising:
an outer frame assembly pivotally connected to the associated vehicle rack, said outer frame including:
a first longitudinally extending rail,
a second longitudinally extending rail spaced from said first rail, and
at least one transverse member connected to at least one of said first rail and said second rail;
an inner frame assembly including first and second longitudinally extending rails, said first rail being telescopically housed in said first rail of said outer frame assembly, said second rail being telescopically housed in said second rail of said outer frame assembly; and
a lifting system operably connected to said outer frame assembly for pulling the associated boat onto the loader and for allowing the associated boat to be controllably lowered off the loader.

15. The loader of claim 14, wherein said first and second rails of said outer frame assembly are pivotally connected to the associated vehicle rack.

16. The loader of claim 14, wherein said at least one transverse member of said outer frame assembly is pivotally connected to the associated vehicle rack.

17. The loader of claim 14, wherein said lifting system includes:
a winch mounted to one of said loader and the associated vehicle rack,
at least one pulley mounted to said outer frame assembly, said at least one pulley being operably connected to said winch, and
a cable operably engaged with said at least one pulley, said cable having a first end section connected to said winch and a second end section connected to the associated boat.

18. A loader releasably mounted to an associated vehicle rack, the loader having a first generally horizontal position for transporting an associated boat and a second position inclined downwardly at an angle of inclination to the generally horizontal first position for launching and loading the associated boat in a predominately upright position, the loader comprising:
a generally ladder-shaped outer frame assembly having a first end section pivotally mounted to the associated vehicle rack;
a generally U-shaped inner frame assembly telescopically housed in said outer frame assembly for movement between a stowed position and an extended position; and
a winch system operably connected to one of said outer frame assembly and the associated vehicle rack for pulling the associated boat onto the loader and for allowing the associated boat to be controllably lowered off the loader.

19. The loader of claim 18, further including an end assembly connected to and extending generally perpendicular from an end section of said outer frame assembly and at least one strengthening member connected to said outer frame assembly and said end assembly.

20. The loader of claim 18, wherein in said second position, the loader is approximately twice the length of the associated boat.
